(19) United States
(12) Patent Application Publication
(10) Pub. No.: US 2016/0379586 A1
(43) Pub. Date: Dec. 29, 2016

(54) GATE DRIVING CIRCUIT AND IMAGE DISPLAY SYSTEM

(71) Applicant: InnoLux Corporation, Miao-Li County (TW)

(72) Inventors: Chun-Fu WU, Miao-Li County (TW); Wen-Tsai HSU, Miao-Li County (TW); Chien-Hsueh CHIANG, Miao-Li County (TW)

(21) Appl. No.: 15/191,047

(22) Filed: Jun. 23, 2016

(30) Foreign Application Priority Data
Jun. 25, 2015 (TW) 104120471

(51) Int. Cl. G09G 3/36; G06F 3/041; G06F 3/044

(52) U.S. Cl. CPC G09G 3/3677; G06F 3/044; G06F 3/0412; G09G 2310/0286

(57) ABSTRACT

A gate driving circuit includes a plurality of shift registers connected in series. The shift registers include a plurality of output shift registers and X groups of dummy shift registers. The output shift registers output the gate driving signal to a plurality of gate driving lines of the pixel matrix in sequence. At least one of the X groups of dummy shift registers has J dummy shift registers and is connected between two adjacent output shift registers in the output shift registers, wherein at least one driving signal generated by the group of dummy shift registers is partially overlapped with the gate driving signal generated by the two adjacent output shift registers in a frame, wherein the X groups of dummy shift registers are not connected to the gate driving lines, and X and J are integers greater than zero.

### CROSS REFERENCE TO RELATED APPLICATIONS

This application claims priority of Taiwan Patent Application No. 104120471, filed on Jun. 25, 2015, the entirety of which is incorporated by reference herein.

### BACKGROUND OF THE INVENTION

Field of the Invention

The present invention relates to a shift register module, and in particular to a gate driving circuit having a plurality of shift registers outputting gate driving signals with rising edges and falling edges which are with less influence from the touch sensing period.

Description of the Related Art

Shift registers are used widely in data transmission circuits for controlling the timing of receiving data signals at respective data lines, and they are used in gate driving circuits for generating gate driving signals at respective gate lines. In data transmission circuits, the shift registers are arranged to output a selection signal to respective data lines, and image data can be written into respective data lines in sequence. Furthermore, in gate driving circuits, the shift registers are arranged to provide a scan signal to a respective gate line to turn on the pixels of the pixel matrix in sequence, so that the image signal can be written to the respective data lines.

Recently, amorphous silicon TFT gate driver circuit (ASG) technology has been developed. In ASG technology, a gate driving circuit comprising thin film transistors (TFTs) is directly integrated into the display panel (i.e., the glass substrate of the display) during the amorphous silicon TFT process to take the place of gate driver chips. This technology also is called gate driver on panel (GOP) technology. Thus, the fabrication cost and cycle time can be reduced by ASG technology or GOP technology to reduce the use of chips in the display panel.

In current in-cell touch display panels, the touch function is integrated into the display pixels, and thus, there is no need to include a touch device other than display pixels into the display panel. For example, the touch function is integrated into liquid-crystal display (LCD) pixels or OLED pixels, and the touch function is implemented by using the electrode structures of the display pixel, so there is no need for additional touch structures. For example, when the in-cell touch display panel is a fringe field switch (FFS) LCD device, its common electrodes are usually patterned and divided into several portions to serve as touch sensing electrodes, so that the overall thickness and weight of the touch display panel can be reduced. Because the touch function is integrated into the LCD display pixels, each frame should be divided to include one or more touch sensing periods for touch detection. However, during the touch sensing periods, clock signals provided to the shift registers in the gate driving circuit are suspended or paused, and the rising edges or falling edges of gate driving signals from some shift registers are improperly extended, and the display quality of the touch display panel is degraded. Thus, there is a need for a new shift register structure capable of solving this problem.

### BRIEF SUMMARY OF THE INVENTION

A detailed description is given in the following embodiments with reference to the accompanying drawings.

The invention provides an embodiment of a gate driving circuit. The gate driving circuit generates a plurality of gate driving signals to drive a pixel matrix with a plurality of pixels on a touch display panel. The gate driving circuit comprises a plurality of shift registers connected in series, and the plurality of shift registers comprises a plurality of output shift registers and X groups of dummy shift registers. The output shift registers output the gate driving signal to a plurality of gate driving lines of the pixel matrix in sequence. At least one of the X groups of dummy shift registers comprises J dummy shift registers and is connected between two adjacent output shift registers. At least one driving signal generated by the group of dummy shift registers is partially overlapped with the gate driving signal generated by the two adjacent output shift registers in a frame, wherein the X groups of dummy shift registers are not connected to the gate driving lines, X is the number of groups of dummy shift registers, J is the number of dummy shift registers, and X and J are integers greater than zero. The present invention also provides an embodiment of an image display system including the gate driving circuit mentioned above.

### BRIEF DESCRIPTION OF THE DRAWINGS

The present invention can be more fully understood by reading the subsequent detailed description and examples with references made to the accompanying drawings, wherein:

FIG. 1A is a diagram of an image display system according to the invention;

FIG. 1B is another diagram of an image display system according to the invention;

FIG. 1C is another diagram of an image display system according to the invention;

FIG. 2 is a diagram of a gate driving circuit shown in FIG. 1A according to the invention;

FIG. 3 shows an embodiment of a shift register according to the invention;

FIG. 4 is a timing diagram of the shift register shown in FIG. 3 during a forward scan;

FIG. 5 shows another embodiment of a shift register according to the invention;

FIG. 6 is a timing diagram of the shift register shown in FIG. 5 during a reverse scan;

FIG. 7 shows a frame of the touch display panel according to the invention;

FIG. 8 shows another embodiment of the gate driving circuit according to the invention;

FIG. 9A is a diagram showing clocks and a touch sensing period according to the invention;

FIG. 9B is another diagram showing clocks and a touch sensing period according to the invention;

FIG. 10 shows another embodiment of the gate driving circuit according to the invention;

FIG. 11A is a timing diagram of the gate driving circuit shown in FIG. 10 when operating in the forward scan;

FIG. 11B is a timing diagram of the gate driving circuit shown in FIG. 10 when operating in the reverse scan;

FIG. 12 shows another embodiment of the gate driving circuit according to the invention;

FIG. 13A is a timing diagram of the gate driving circuit shown in FIG. 12 when operating in the forward scan; and

FIG. 13B is a timing diagram of the gate driving circuit shown in FIG. 12 when operating in the reverse scan.

### DETAILED DESCRIPTION OF THE INVENTION

The description is made for the purpose of illustrating the general principles of the invention and should not be taken in a limiting sense. The scope of the invention is best determined by reference to the appended claims.

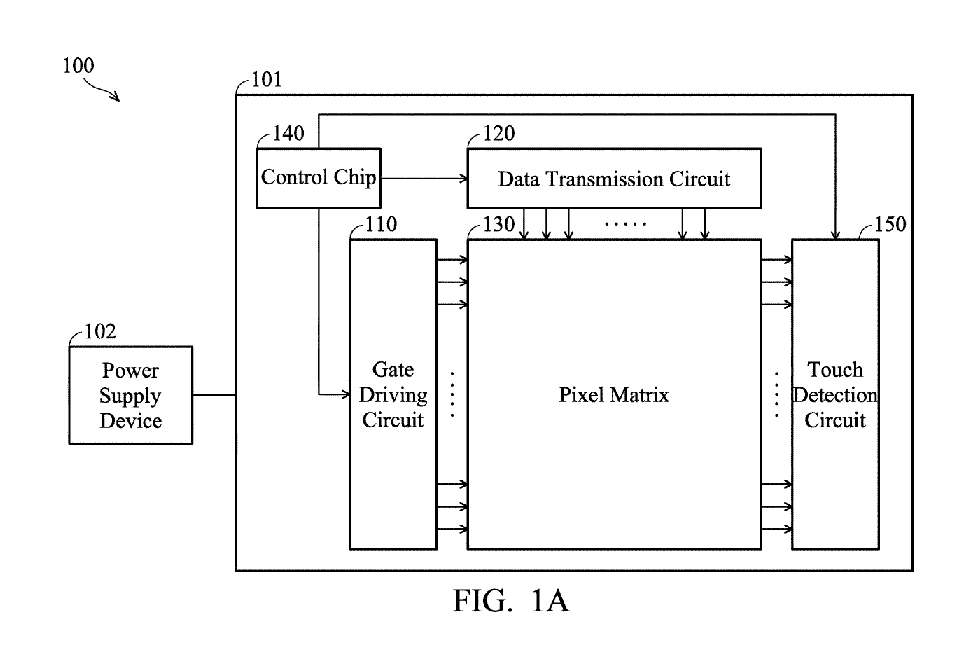

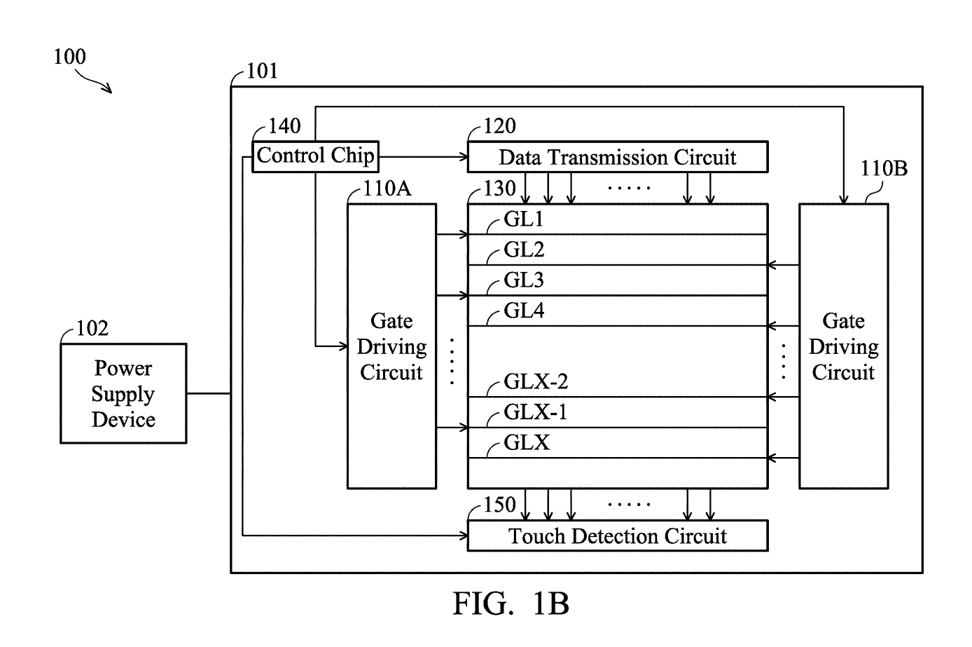

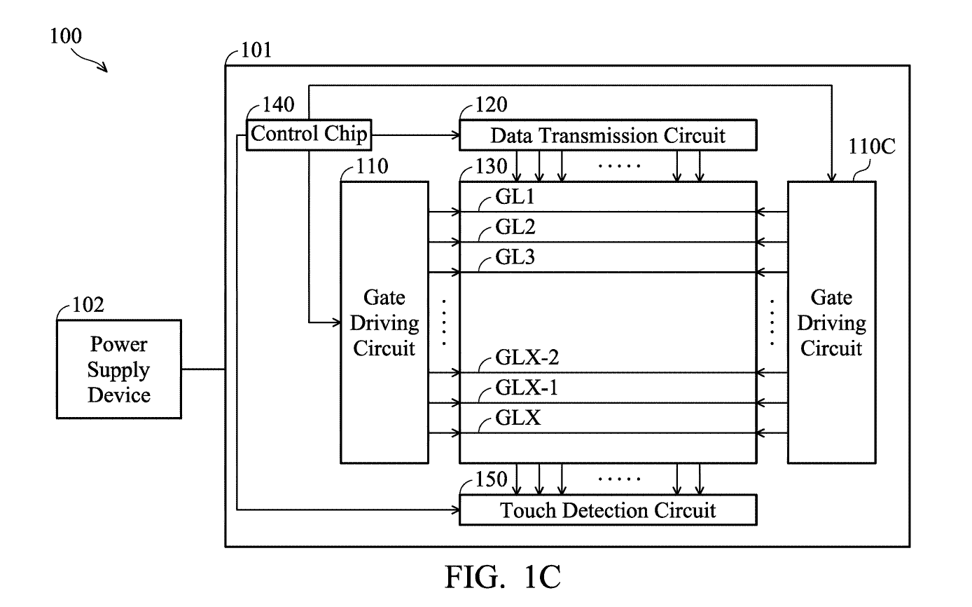

FIG. 1 shows an embodiment of an image display system of the present invention. As shown in FIG. 1, the image display system comprises a touch display panel 101 to display images and sense the touch of an external object. In one embodiment, the touch display panel 101 is an in-cell touch display panel, but it is not limited thereto. For example, the touch display panel 101 can also be an on/out-cell touch display panel, or an in/on-cell touch display panel. The display touch panel 101 comprises a gate driving circuit 110, a data signal transmission circuit 120, a pixel matrix 130, a control chip 140 and a touch detection circuit 150. The data signal transmission circuit 120, the control chip 140 and the touch detection circuit 150 can be separate chips or can be integrated into a single chip, but it is not limited thereto. In some embodiments, only the data signal transmission circuit 120 and the touch detection circuit 150 are integrated into a single chip.

The gate driving circuit 110 is arranged to generate a plurality of gate driving signals to drive a plurality of pixels of the pixel matrix 130. The data signal transmission circuit 120 is arranged to generate a plurality of data signals to provide data to the pixels of the pixel matrix 130. For example, the pixel matrix 130 comprises a plurality of gate lines, a plurality of data lines and a plurality of pixels. In some embodiments, the pixels of the pixel matrix 130 and a plurality of sensing electrodes for touch sensing are integrated together, so that the touch display panel 101 can display images and sense the touch of the external object. The control chip 140 is arranged to generate a plurality of control signals comprising clock signals and a start pulse. The touch detection circuit 150 generates a touch position data according voltages or charge variation on the sensing electrodes and outputs the touch position data to an external processor for subsequent processing. For example, the sensing electrodes senses capacitance variation when the touch display panel is touched by a stylus or a finger, converts the sensed capacitance variation into voltages, and then the touch detection circuit 150 detects such variation. In one embodiment, the pixel matrix 130 is disposed on a substrate, and the gate driving circuit 110 is fabricated on the substrate by amorphous silicon TFT gate driver circuit (ASG) technology to form a gate driver on panel (GOP).

Furthermore, the image display system of the present invention can be included in an electronic device 100. The electronic device 100 comprises the touch display panel 101 and a power supply device 102 arranged to power the touch display panel 101. In some embodiments, the electronic device 100 can be a mobile phone, a digital camera, a personal digital assistant (PDA), a mobile computer, a desktop computer, a television, a car display, a mobile disk player, or any device capable of displaying images. According to embodiments of the invention, the gate driving circuit 110 can output gate driving signals to the gate lines in sequence with different scanning sequences (e.g., a forward scan sequence and a reverse scan sequence) so that the video signals on the data lines can be written to the pixels of the pixel matrix 130 in sequence.

FIG. 1B shows another embodiment of the image display system of the present invention. As shown, the image display system comprises gate driving circuits 110A and 110B. The gate driving circuit 110A is arranged to drive odd-numbered gate lines, such as GL1, GL3, . . . , GLX−1, and the gate driving circuit 110B is arranged to drive even-numbered gate lines, such as GL2, GL4, . . . , GLX. The gate driving circuits 110A and 110B are disposed on different sides of the touch display panel 101, and it is beneficial to border symmetry. Specifically, the gate driving circuit is divided into two portions and disposed on opposite sides of the active area (i.e., display area) to output odd-numbered driving signals and even-numbered driving signals. This design can avoid overcrowding on the non-display area because the gate driving circuits are disposed on one side. Thus, the touch display panel can have a narrow border, a uniform routing area, and identical border areas on opposite sides.

FIG. 1C shows another embodiment of the image display system of the present invention. As shown, the image display system comprises gate driving circuits 110 and 110C disposed on opposite sides of the active area. Each gate line of the pixel matrix 130 is driven by one shift register in the gate driving circuit 110 and one shift register in the gate driving circuit 110C together so that the gate driving circuits 110 and 110C can be operated under a heavy load. For example, in large-size panels (larger than 17 inch), the loading (i.e., resistance-capacitance loading) of each gate line is heavy because of greater length. Thus, the gate line GL1 is driven by shift registers SR1 in both gate driving circuits 110 and 110C, and so on.

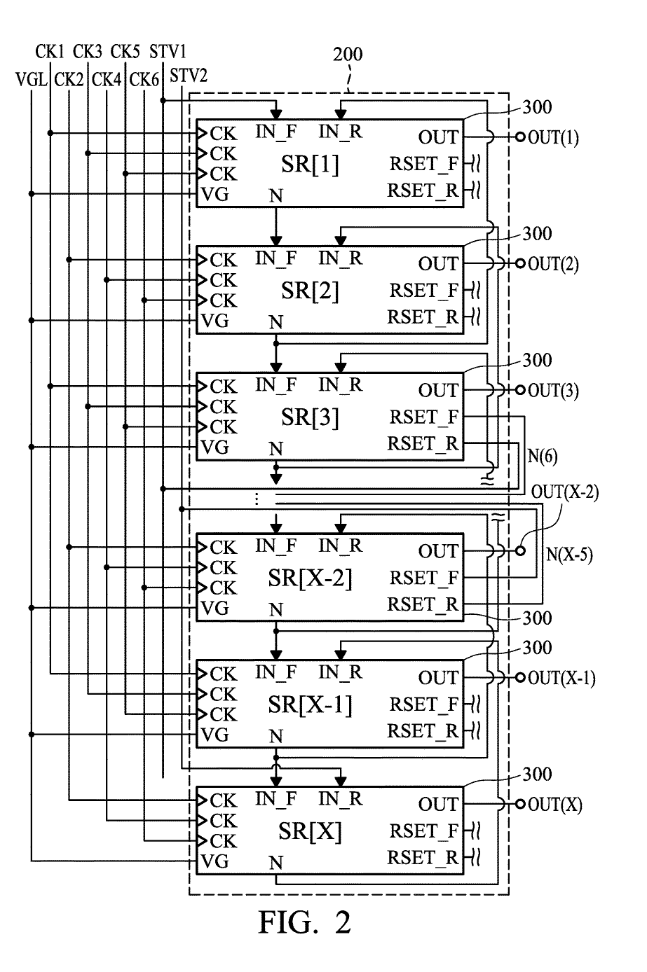

FIG. 2 is a diagram of the gate driving circuit 110A shown in FIG. 1A of the present invention. The gate driving circuit 110A comprises X shift registers 300 connected in series, i.e., shift registers SR[1], SR[2], SR[3], . . . , SR[X−2], SR[X−1] and SR[X], wherein X is an positive integer. Each shift register comprises a plurality of clock input terminals CK, a voltage input terminal VG, a forward input terminal IN_F, a reverse input terminal IN_R, an output terminal OUT, a signal transmission terminal N, and a forward reset input terminal REST_F and a reverse reset input terminal REST_R. The signal transmission terminal N and the output terminal OUT of each shift register output the same driving signal, so that the pulses of the driving signals are delivered between the shift registers in sequence.

When the gate driving circuit 110A is operated in forward scan, the shift registers 300 output driving signals in a first sequence. For example, shift registers SR[1] to SR[X] output driving signals OUT(1), OUT(2), OUT(3), . . . , OUT(X−2), OUT(X−1) and OUT(X) in sequence. Conversely, when the gate driving circuit 110A is operated in reverse scan, OUT(X), OUT(X−1), OUT(X−2), . . . , OUT(3), OUT(2) and OUT(1) are output in sequence.

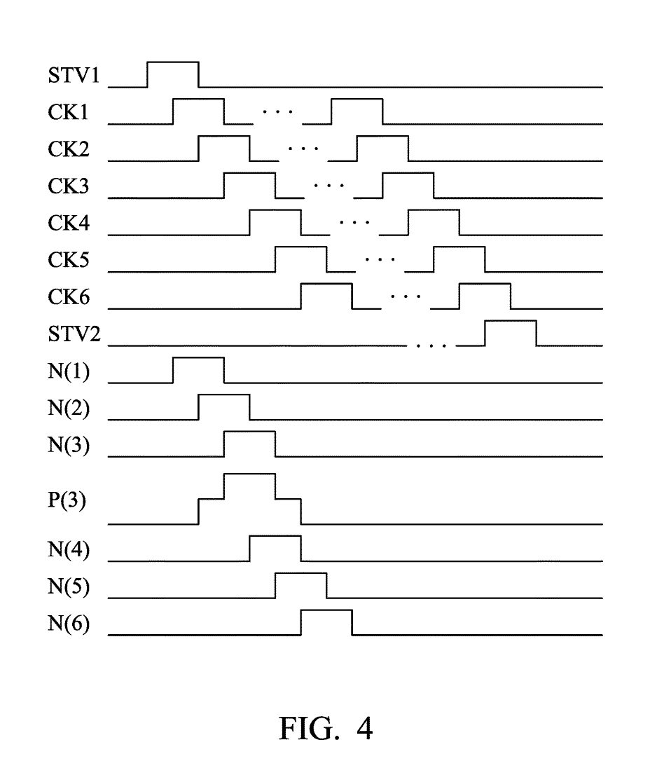

The gate driving circuit 110 receives a plurality of control signals comprising clock signals CK1, CK2, CK3, CK4, CK5 and CK6, start pulses STV1 and STV2, and a constant voltage VGL, from the control chip 140. Generally, in the clock signals CK1 to CK6, two sequential clock signals have an overlapped half pulse. For example, as shown in the timing diagram of FIG. 4, the former half pulse of the clock signal CK2 is overlapped with the latter half pulse of the clock signal CK1, and the former half pulse of the clock signal CK3 is overlapped with the latter half pulse of the clock signal CK2. The clock signals CK1, CK3 and CK5 are provided to odd-numbered/even-numbered shift registers and the clock signals CK2, CK4 and CK6 are provided to even-numbered/odd-numbered shift registers.

The start pulses STV1 and STV2 are arranged to enable the gate driving circuit 110. As shown, the first shift register SR[1] of the gate driving circuit 110A receives the start pulse STV1 at its forward input terminal IN_F to serve as a forward input signal, and the last shift register SR[X] of the gate driving circuit 110A receives the start pulse STV2 at its reverse input terminal IN_R to serve as a reverse input signal. In addition, each shift register receives the driving signal from the previous shift register at its forward input terminal IN_F to serve as a forward input signal and receives the driving signal from the next shift register at its reverse input terminal IN_R to serve as a reverse input signal.

In one embodiment of the present invention, the N^{th} shift register receives the driving signal from the N+2^{th} shift register or the N+3^{th} shift register at its forward reset input terminal REST_F to serve as a forward reset signal and receives the driving signal from the N−2^{th} shift register or the N−3^{th} shift register at its reverse reset input terminal REST_R to serve as a reverse reset signal. In another embodiment of the present invention, the N^{th} shift register receives the driving signal from the N+A^{th} shift register at its forward reset input terminal REST_F to serve as a forward reset signal and receives the driving signal from the N-A^{th} shift register at its reverse reset input terminal REST_R to serve as a reverse reset signal, wherein A is equal to 1 or larger than 1. In addition, the coupling method of the forward and reverse reset signals of first several shift registers and last several shift registers in the gate driving circuit have a special design, thereby avoiding timing errors.

For example, as shown in FIG. 2, the reverse reset input terminals REST_R of the shift registers SR[1], SR[2] and SR[3] are connected to the start pulse STV1, and the forward reset input terminals REST_F of the shift registers SR[1], SR[2] and SR[3] are respectively connected to the signal transmission terminals N[4], N[5] and N[6] of the shift registers SR[4], SR[5] and SR[6]. The forward reset input terminals REST_F of the shift registers SR[X−2], SR[X−1] and SR[X] are connected to the start pulse STV2, and the reverse reset input terminals REST_R of the shift registers SR[X−2], SR[X−1] and SR[X] are respectively connected to the signal transmission terminals N[X−5], N[X−4] and N[X−3] of the shift registers SR[X−5], SR[X−4] and SR[X−3]. Each of the shift registers SR[4] to SR[X−3] other than the shift registers SR[1], SR[2], SR[3], SR[X−2], SR[X−1] and SR[X] receives the driving signal from one of the following shift registers at its forward reset input terminal to serve as a forward reset signal, and receives the driving signal form one of the previous shift registers at it reverse reset input terminal to serve as a reverse reset signal. For example, the forward reset input terminal REST_F and the reverse reset input terminal REST_R of the shift register SR[4] are respectively connected to the signal transmission terminals of the shift register SR[7] and the shift register SR[1], the forward reset input terminal REST_F and the reverse reset input terminal REST_R of the shift register SR[5] are respectively connected to the signal transmission terminals of the shift register SR[8] and the shift register SR[2], and so on.

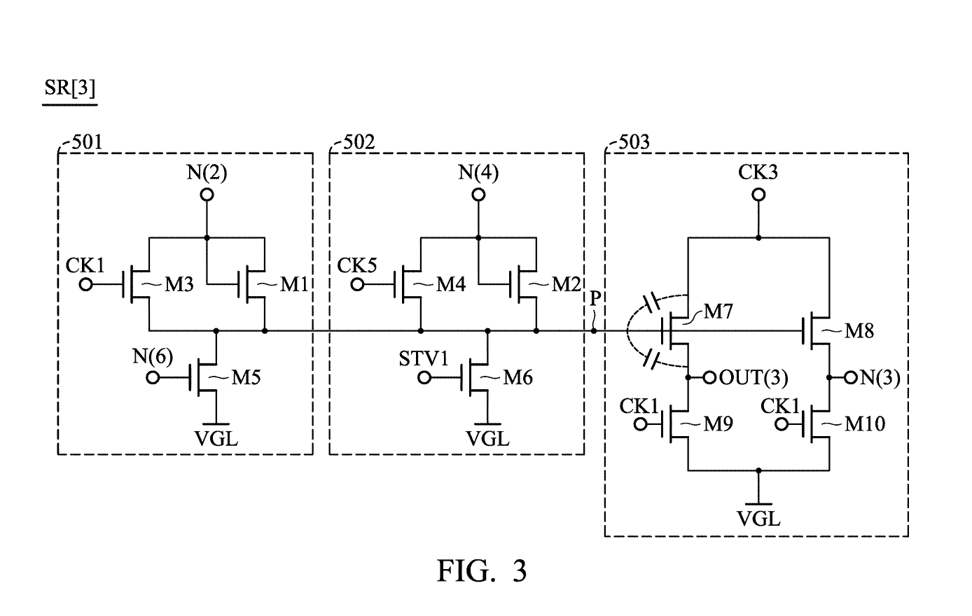

FIG. 3 is a circuit diagram of another embodiment of the shift register according to the invention. FIG. 4 is a timing diagram of the shift register shown in FIG. 3 when operating in the forward scan. In this embodiment, the shift register SR[3] is the 3^{rd} shift register in the gate driving circuit 110A comprising a forward input circuit 501, a reverse input circuit 502 and an output circuit 503. The shift register is implemented by NMOS transistors M1-M10. During the forward scan, the transistor M3 is turned on because of the pulse of the clock signal CK1, and the control node P is coupled to the forward input signal N(2). At this time, because the forward input signal N(2) is maintained at a low voltage level, the voltage at the control node P is maintained at a low voltage level. When the pulse of the forward input signal N(2) arrives, the transistor M1 is turned on to pre-charge the voltage at the control node P to a first high voltage level (i.e., signal P(3) shown in FIG. 4).

Because the control terminal is at a high voltage level, transistors M7 and M8 are turned on, and the pulse of the clock signal CK3 can be delivered to the output terminal OUT and the signal transmission terminal N. Thus, when the transistors M7 and M8 are being turned on, the driving signal OUT(3) and the signal N(3) have the same phase. In addition, when the pulse of the clock signal CK3 is at a high voltage level, the voltage at the control node P is further charged to a second high voltage level by the parasitic capacitor (or additional coupled capacitor) to increase the gate voltage of the transistors M7 and M8. A higher gate voltage is conducive to increasing the charging speed and the discharge speed of the output terminal OUT and the signal transmission terminal N.

When the pulse of the clock signal CK3 is terminated, the voltage at the control node P starts to discharge to the first high voltage level because the drain voltages of the transistors M7 and M8 are pulled to a low voltage level. Then, when the pulse of the forward reset signal N(6) arrives, the transistor M5 is turned on, and the control node P is coupled to the constant voltage VGL and is further discharged to a low voltage level.

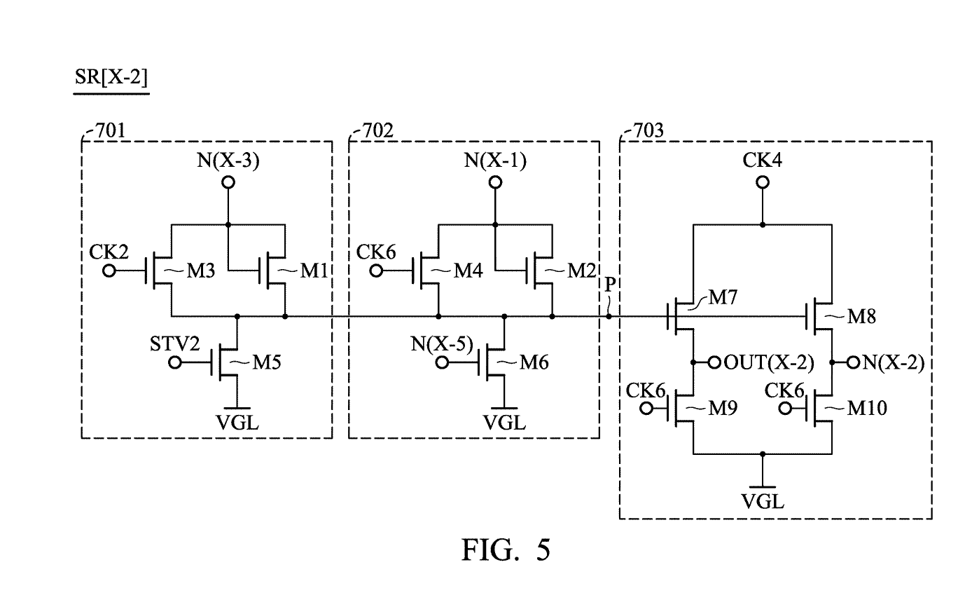

As mentioned above, when operating in the forward scan, the forward input circuit acts as a primary circuit to control the voltage at the control node P and the reverse input circuit acts as an auxiliary circuit to assist the forward input circuit. Please refer to FIG. 5. The pulses of the signal N(4) and the clock signal CK5 respectively turn on the transistors M2 and M4 to assist the signal holding of the control node P.

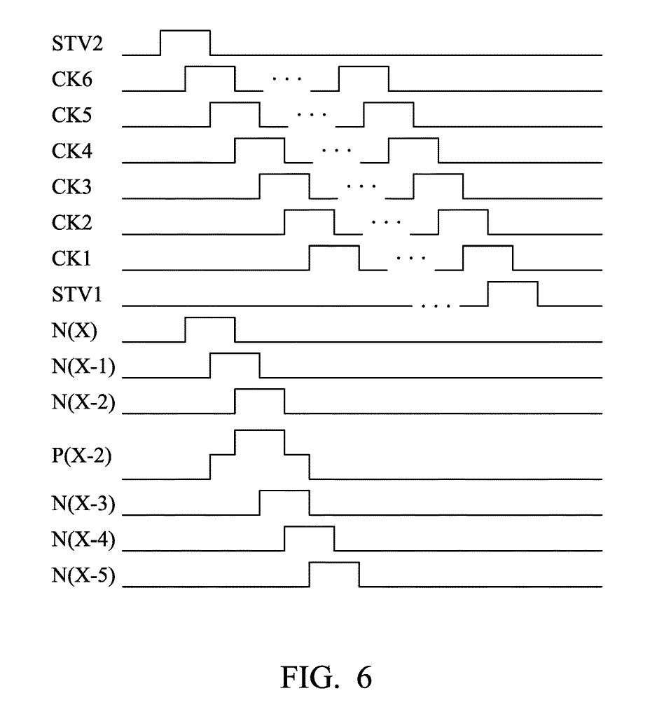

FIG. 5 is a circuit diagram of another embodiment of the shift register according to the invention. FIG. 6 is a timing diagram of the shift register shown in FIG. 5 when operating in the reverse scan. In this embodiment, the shift register SR[X−2] is the X−2^{th} shift register in the gate driving circuit 110A comprising a forward input circuit 701, a reverse input circuit 702 and an output circuit 703. The shift register is implemented by NMOS transistors M1-M10. During the reverse scan, the gate driving circuit 110A is enabled by the start pulse STV2, and the sequence of the clock signal CK1 to CK6 is reverse as shown in FIG. 6. The transistor M4 is turned on because of the pulse of the clock signal CK6, and the control node P is coupled to the reverse input signal N(X−1). At this time, because the reverse input signal N(X−1) is maintained at a low voltage level, the voltage at the control node P is maintained at a low voltage level. When the pulse of the reverse input signal N(X−1) arrives, the transistor M2 is turned on to pre-charge the voltage at the control node P to the first high voltage level (i.e., signal P(X−2) shown in FIG. 6).

Because the control terminal is at a high voltage level, transistors M7 and M8 are turned on, and the pulse of the clock signal CK4 can be delivered to the output terminal OUT and the signal transmission terminal N. Thus, when the transistors M7 and M8 are being turned on, the driving signal OUT(X−2) and the signal N(X−2) have the same phase. In addition, when the pulse of the clock signal CK4 is at a high voltage level, the voltage at the control node P is further charged to a second high voltage level by the parasitic capacitor (or an additional coupled capacitor) to increase the gate voltage of the transistors M7 and M8. A higher gate voltage is conducive to increasing the charging speed and the discharge speed of the output terminal OUT and the signal transmission terminal N.

When the pulse of the clock signal CK4 is terminated, the voltage at the control node P starts to discharge to the first high voltage level because the drain voltages of the transistors M7 and M8 are pulled to a low voltage level. Then, when the pulse of the forward reset signal N(X−5) arrives, the transistor M6 is turned on, so that the control node P is coupled to the constant voltage VGL and is further discharged to a low voltage level.

As mentioned above, when operating in the reverse scan, the reverse input circuit acts as a primary circuit to control the voltage at the control node P and the forward input circuit acts as an auxiliary circuit to assist the reverse input circuit. Please refer to FIG. 5. The pulses of the signal N(X−3) and the clock signal CK2 respectively turn on the transistors M1 and M3 to assist the signal holding of the control node P.

In addition, the gate driving circuit is implemented by the shift registers capable of operating in dual direction scans (i.e., forward scan and reverse scan) shown in FIGS. 2-6, the present invention is not limited thereto. In some embodiments, the gate driving circuit can also be implemented by the shift registers which can only be operated in a single direction (i.e., forward scan).

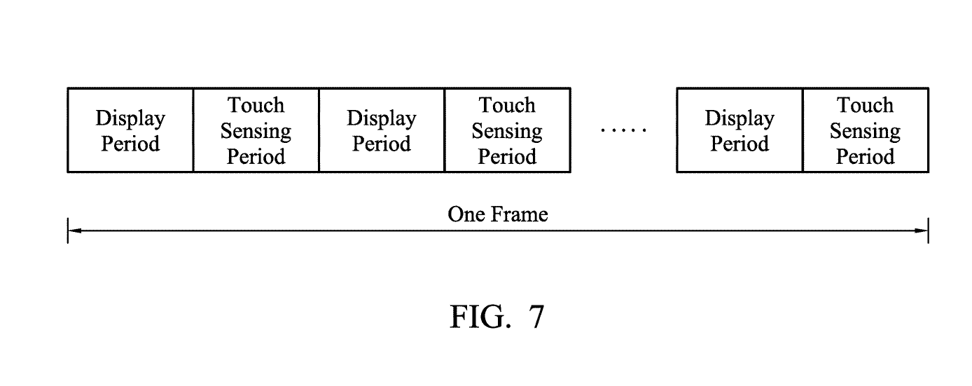

FIG. 7 is a diagram of a frame of the touch display panel according to the invention. Because the touch display panel is an in-cell touch display panel, each frame has a plurality of display periods and a plurality of touch sensing periods. As shown, the display periods and the touch sensing periods are arranged alternately. More specifically, the display periods and the touch sensing periods are periodically arranged in turn in one frame. For example, N shift registers operating in the display periods are divided into M groups of shift registers, and each group has the same amount of shift registers. In another embodiment, the display periods and the touch sensing periods are aperiodically arranged in turn in one frame. For example, N shift registers operating in the display periods are divided into M groups of shift registers, and the M groups have different amounts of shift registers. In another embodiment, one frame has only one touch sensing period, and the display period is divided into two portions in this frame, and the touch sensing period is arranged between the two portions. Similarly, the amounts of the shift registers in the two portions of the display period can be the same or different. Please refer to FIG. 7 again. During each display period, one group of shift registers in the gate driving circuit 110 outputs a group of gate driving signals in sequence to drive a group of corresponding gate lines in the pixel matrix 103, and during each touch sensing period, the sensing electrodes perform touch sensing. In some embodiments, each touch sensing period is arranged between two display periods. In FIG. 7, the display periods and the touch sensing periods are both even. In some embodiments, one frame has even display periods and odd touch sensing periods or has odd display periods and even touch sensing periods, so that the last period of the frame is a display period to maintain the original display performance of the touch display panel.

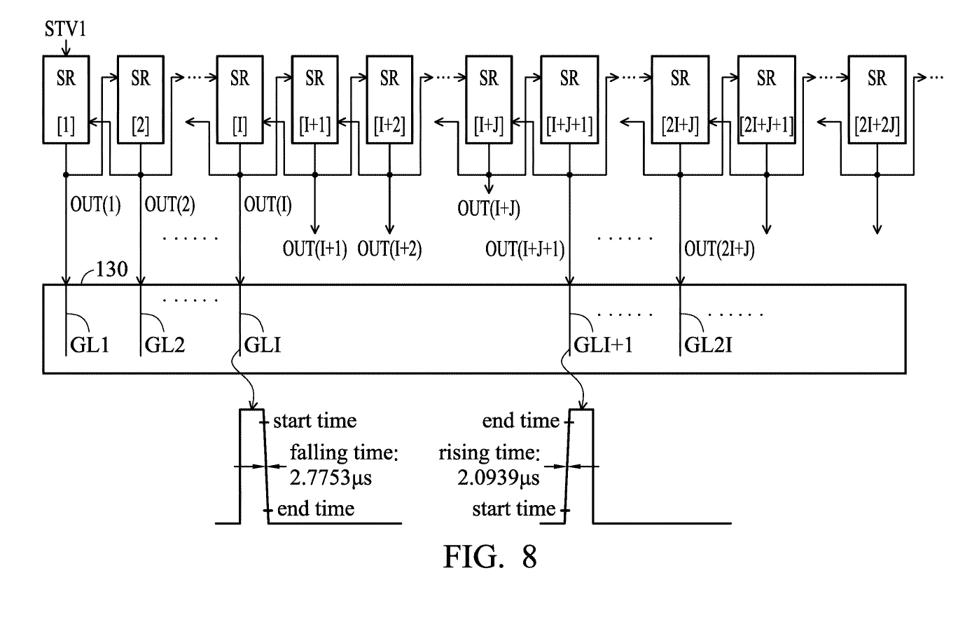

FIG. 8 is another diagram of the gate driving circuit according to the invention. As shown, the gate driving circuit comprises a plurality of shift registers connected in series, such as SR[1], SR[2], . . . , SR[2I+2J]. Each shift register has the same circuit connection as shown in FIG. 2, and has the same circuit structure and operation mentioned in FIG. 3 to FIG. 6. It should be noted that the shift registers in the gate driving circuit shown in FIG. 8 are divided into two types, i.e., output shift registers, such as SR[1] to SR[I] and SR[1+J+1] to SR[2I+J], and dummy shift registers, such as SR[I+1] to SR[I+J] and SR[21+J+1] to SR[2I+2J]. The output terminals of the output shift registers are connected to the corresponding gate lines of the pixel matrix 130 respectively, thereby outputting the driving signals to the gate lines of the pixel matrix 130 in sequence. For example, the output terminal of the shift register SR[1] is connected to the gate line GL1, the output terminal of the shift register SR[2] is connected to the gate line GL2, and so on. In some embodiments, the shift registers SR[1] to SR[I] can be regarded as a group of output shift registers, the shift register SR[I+J+1] to SR[2I+J] can be regarded as the next group of output shift registers and so on.

The output terminals of the dummy shift registers are not connected to the gate lines of the pixel matrix 130. For example, the output terminal of the shift register SR[I+1] is connected to the shift registers SR[I] and SR[I+2], the output terminal of the shift register SR[I+2] is connected to the shift registers SR[I+1] and SR[I+3], and so on. In some embodiments, the shift registers SR[I+1] to SR[I+J] can be regarded as a group of dummy shift registers connected between two adjacent shift registers SR[I] and SR[I+J+1] of the output shift registers, the shift registers SR[2I+J+1] to SR[2I+2J] can be regarded as the next group of dummy shift registers connected between two adjacent shift registers SR[2I+J] and SR[2I+2J+1] (not shown) of the output shift registers, and so on. For example, the gate driving circuit can comprise X groups of dummy shift registers, wherein X, I and J are integers greater than zero. The dummy shift registers are merely arranged to deliver pulses of the driving signals in touch sensing periods, so that the waves of the control terminals of the shift registers (for example, SR[I], SR[I+J+1] and SR[2I+J]) of the output shift registers, which output gate driving signals close to the rising edge and the falling edge of the touch sensing period, are substantially the same as that of the other shift registers of the output shift registers, such as SR[1] to SR[I−1] and SR[I+J+2] to SR[2I+J−1].

It should be noted that, in this embodiment, the control chip 140 does not stop providing a group of clock signals, such as clock signal CK1 to CK6 and/or the start pulses STV1 and STV2, to the gate driving circuit, but it is not limited thereto. According to the corresponding clock signal, such as one or more of the clock signals CK1 to CK6, each group of dummy shift registers enables one of the two adjacent output shift registers of the output shift registers to perform pre-charging and the other to perform signal holding, thereby controlling the rising edge and/or the falling edge of the two adjacent output shift registers of the output shift registers. In some embodiments, one or more driving signals generated by each group of dummy shift registers partially overlap with the gate driving signals generated by at least one of the two adjacent output shift registers of the output shift registers in a frame, so that during the touch sensing period, one of the two adjacent output shift registers of the output shift registers performs pre-charging and the other performs signal holding.

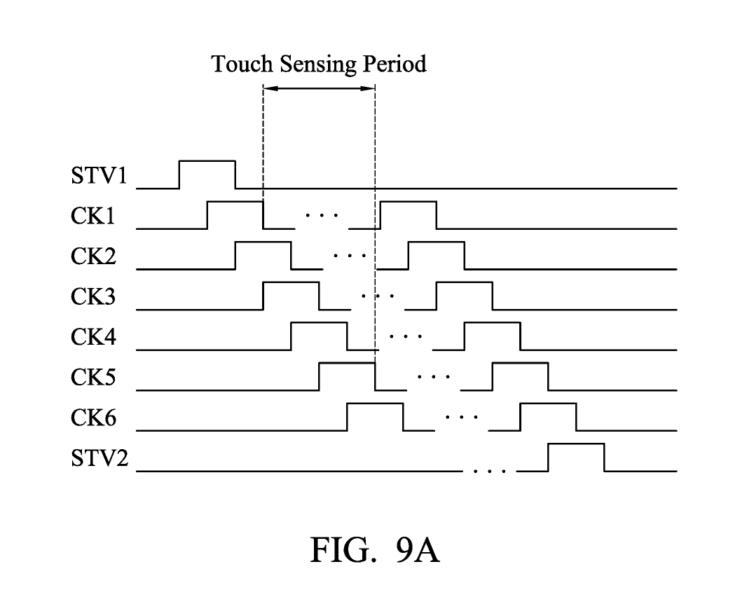

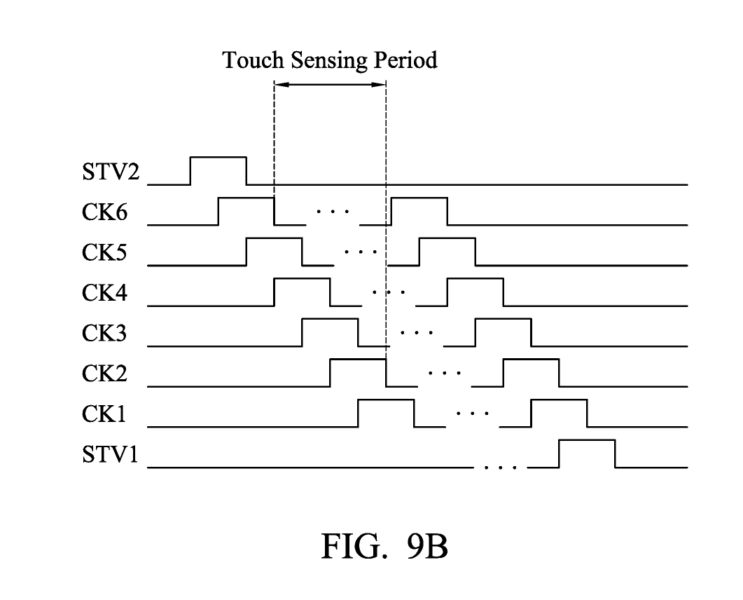

For example, in the forward scan, the first group of dummy shift registers, such as SR[I+1] to SR[I+J], enables the shift register SR[I] to perform signal holding and the shift register SR[I+J+1] to perform pre-charging, thereby controlling the falling edge of the gate driving signal of the shift register SR[I] and the rising edge of the gate driving signal of the shift register SR[I+J+1]. In the reverse scan, the first group of dummy shift registers, such as SR[I+1] to SR[I+J], enable the shift register SR[I+J+1] to perform signal holding and the shift register SR[I] to perform pre-charging, thereby controlling the falling edge of the gate driving signal of the shift register SR[I+J+1] and the rising edge of the gate driving signal of the shift register SR[I]. Because the clock signals CK1 to CK6 are not suspended or paused and the dummy shift registers are maintained to deliver the driving signals, the output signals (i.e., the driving signals from the signal transmission terminals or the output terminals OUT) of all output shift registers, such as SR[1] to SR[I], SR[I+J+1] to SR[2I+.1], have normal rising edges and normal falling edges even during the touch sensing periods, so that display quality of the touch display panel would not be degraded due to the touch sensing periods. The aforementioned pre-charging and signal holding are defined in FIG. 8 and FIG. 9A. The signal holding means when the clock signal CK1 is overlapped with the clock signal CK2, and if the touch sensing period begins after the clock signal CK1 is terminated, the clock signal CK2 can be provided to the dummy shift register, such as the 36^{th} shift register, to output the driving signal to the 35^{th} shift register (it is supposed that the 35^{th} shift register is the last one of the first group of shift registers) to hold the output of the 35^{th} shift register when clock signal CK1 is suspended or paused. At this time, the driving signal from the 35^{th} shift register is partially overlapped with the driving signal from the 36^{th} shift register. The pre-charging means when the clock signal CK5 is overlapped with the clock signal CK6, and the clock signal CK6 is provided to another dummy shift register, such as the 39^{th} shift register, to output the driving signal to the 40^{th} shift register (it is supposed that the 40^{th} shift register is the first one of the second group of shift registers) to hold the output of the 40^{th} shift register when the clock signal CK5 is suspended or paused (i.e., the touch sensing period comprising 4 clock periods is terminated). At this time, the driving signal from the 39^{th} shift register is partially overlapped with the driving signal from the 40^{th} shift register. Please refer to FIG. 8 again. FIG. 8 also shows an improved example of the falling edge and the rising edge when operating the gate driving circuit in the present invention. The measured falling time (from 10% (i.e., start time) to 90% (i.e., end time) of the falling edge) of the output signal from the output shift register SR[I] is about 2.7753 us, and the measured raising time (from 10% (i.e., start time) to 90% (i.e., end time) of the rising edge) of the output signal from the output shift register SR[I+J+1] is about 2.0939 us. In view of this, there is no significant difference between the raising time and the falling time in the gate driving circuit of the present invention. For example, the difference between the falling time of the output shift registers SR[I] and SR[I−1] can be less than about 0.2 us, and the difference between the raising time of the output shift registers SR[I+J+1] and SR[I+J+2] can be less than about 0.2 us.

In FIG. 8, the last shift register can serve as an output shift register or a dummy shift register. It should be noted that the aforementioned dummy shift registers are shift registers for touch sensing rather than the shift registers disposed in a conventional gate driving circuit. The shift registers disposed in a conventional gate driving circuit usually are used to protect the other output shift register from electrostatic effect and malfunction of the touch display panel. Hence, the size of the shift registers disposed in a conventional gate driving circuit is usually larger than the size of the dummy shift registers to protect the touch panel from electrostatic effects.

Furthermore, the size of the dummy shift registers, such as SR[I+1] to SR[I+J] and SR[2I+J+1] to SR[2I+2J], is smaller than size of the output shift registers, such as SR[1] to SR[I] and SR[I+J+1] to SR[2I+J]. Specifically, the size of the transistors in the dummy shift registers is smaller than size of transistors in the output shift register, such as SR[1] to SR[I] or SR[I+J+1] to SR[2I+J]. In one embodiment, the size of the transistors in the dummy shift registers, such as SR[I+1] and SR[I+J], is smaller than size of transistors in the output shift register, such as SR[I] and SR[I+J+1], and the size of the transistors in the dummy shift registers, such as SR[I+2] and SR[I+J−1], is smaller than size of transistors in the dummy shift register, such as SR[I+1] and SR[I+J]. The size of dummy shift registers can be different from the size of the output shift registers. For example, because the output shift registers are required to provide driving signals to the gate lines, but dummy shift registers are not, the driving transistors (i.e., M7 and M8 shown in FIG. 5) in the dummy shift registers can be smaller than the driving transistors in the output shift registers, if the amount and circuit connection of the transistors in the output shift registers and the dummy shift registers are the same. In some embodiments, the size of the dummy shift registers can be equal to that of output shift registers or the size of the driving transistors in the dummy shift registers can be equal to that in output shift registers. Furthermore, J is determined based on the amount of pulses of the clock signals during one touch sensing period. For example, as shown in FIG. 9A, the four pulses of the clock signals CK2, CK3, CK4 and CK5 are within one touch sensing period, and thus J is 4. In some embodiments, six pulses of the clock signals CK1, CK2, CK3, CK4, CK5 and CK6 are within one touch sensing period, and thus J is 6. However, J can be adjusted based on different designs. As mentioned above, the signal transmission terminal N and the output terminal OUT of each shift register output the same driving signal. Thus, the driving signal received by the dummy shift register can be the driving signal from the signal transmission terminal N or output terminal OUT of the output shift register. FIG. 9B is a diagram showing clock signals and touch sensing periods when operating in the reverse scan. Operations of the gate driving circuit is similar to that illustrated in FIG. 9A, and thus, are omitted for brevity.

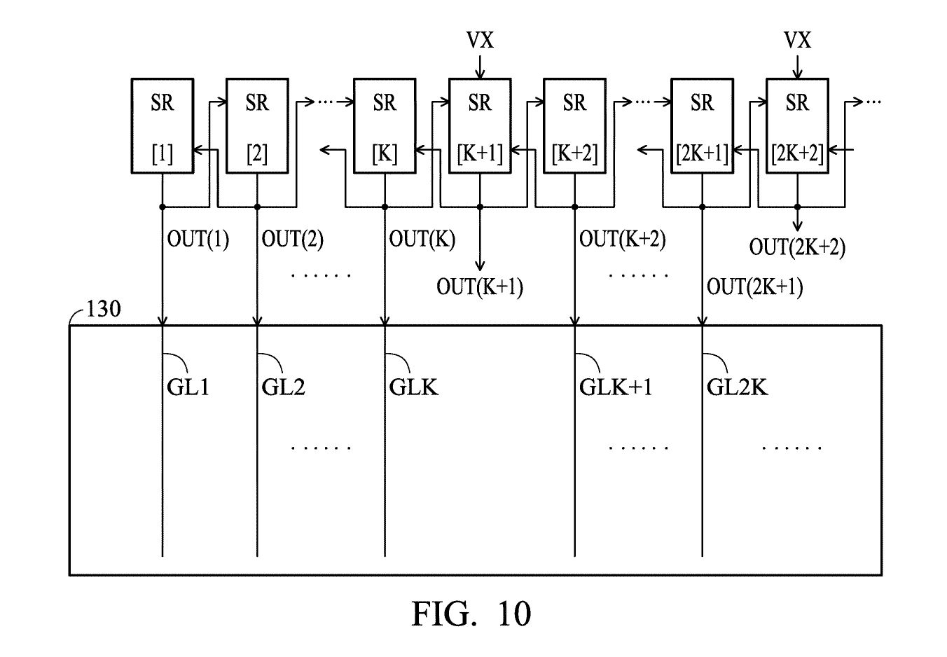

FIG. 10 shows another embodiment of the gate driving circuit in the present invention. The gate driving circuit shown in FIG. 10 is similar to that shown in FIG. 8, and the difference is that only one dummy shift register is disposed between two groups of output shift registers. In this embodiment, during the touch sensing period of the in-cell touch display panel, the control chip suspends or pauses the clock signals CK1 to CK6, and the dummy shift register enables one of the adjacent two output shift registers to perform pre-charging and the other to perform signal holding, according to a specific clock signal VX. The specific clock signal is not one of the clock signals CK1 to CK 6.

For example, the dummy shift register, such as SR[K+1], is disposed between the first group of output shift registers, such as SR[1] to SR[K], and the second group of output shift registers, such as SR[K+2] to SR[2K+1], to enable the shift register SR[K+2] to perform pre-charging and enable the shift register SR[K] to perform signal holding according to the specific clock signal VX. Similarly, the dummy shift register, such as SR[2K+2], is disposed between the second group of output shift registers, such as SR[K+2] to SR[2K+1], and the next group of output shift registers (not shown) to enable the shift register SR[2K+3] (not shown) to perform pre-charging and enable the shift register SR[2K+1] to perform signal holding according to the specific clock signal VX, and so on.

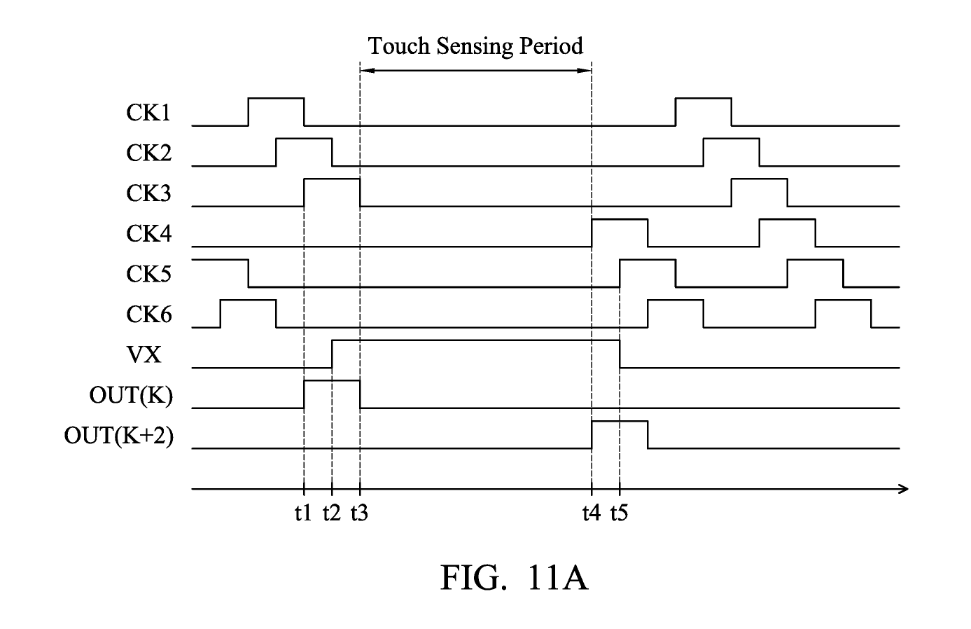

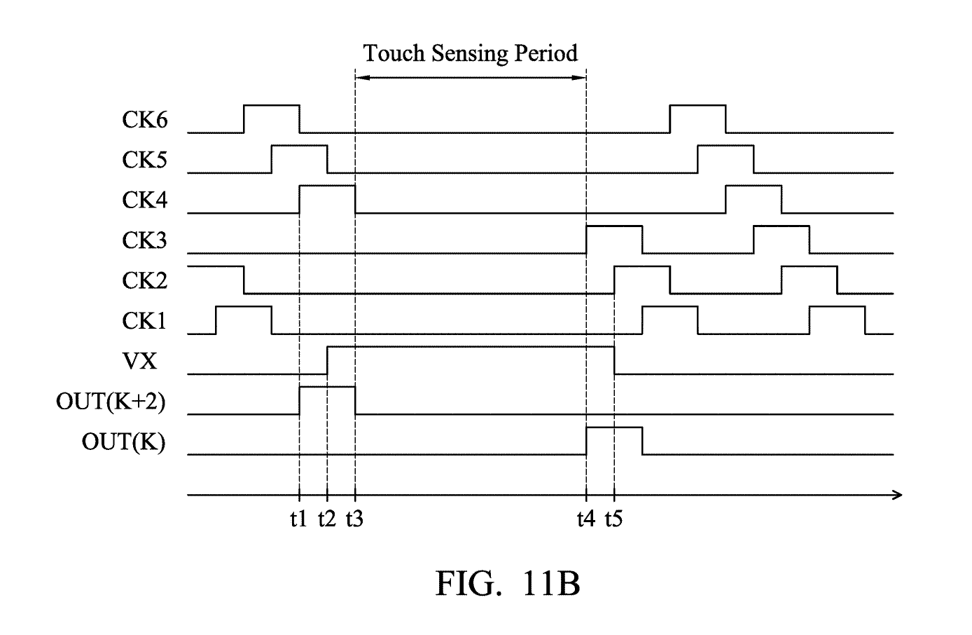

FIG. 11A is a timing diagram of the gate driving circuit shown in FIG. 10 when operating in the forward scan. It is assumed that the output circuit 503 of the shift register SR[K] outputs the driving signal OUT(K) at its output terminal OUT and signal transmission terminal N according to the clock signal CK3, and the output circuit 503 of the shift register SR[K+2] outputs the driving signal OUT(K+2) at its output terminal OUT and signal transmission terminal N according to the clock signal CK4. As shown in FIG. 11, the start time of the rising edge and the start time of the falling edge of the gate driving signal (i.e., the driving signal OUT(K)) from the shift register SR[K] are the same as that of the pulse of the clock signal CK3. The start time of the rising edge and the start time of the falling edge of the gate driving signal (i.e., the driving signal OUT(K+2)) from the shift register SR[K+2] are the same as that of the pulse of the clock signal CK4.

As shown in FIG. 11A, according to the clock signal CK3, the shift register SR[K] outputs the driving signal OUT(K), which is identical to the pulse of the clock signal CK3, to the gate line GLK to serve as the gate driving signal before the touch sensing period (time t1 to t3). At time t2, before the touch sensing period, the dummy shift register SR[K+1] outputs the driving signal OUT(K+1), which is identical to the pulse of the specific clock signal VX, to the shift registers SR[K] and SR[K+2] according to the specific clock signal VX. Namely, during time t2 to t3, before the touch sensing period, the shift register SR[K+2] receives the driving signal OUT(K+1) from the dummy shift register (for example, SR[K+1]) and thus, the transistor M1 in the forward input circuit 501 of the shift register SR[K+2] is turned on to pre-charge the control node P. Similarly, at time t2 to t3, the shift register SR[K] receives the driving signal OUT(K+1) from the dummy shift register (for example, SR[K+1]) and thus, the transistor M2 in the reverse input circuit 502 of the shift register SR[K] is turned on to perform signal holding on the control node P. Then, during the touch sensing period (i.e., time t3 to t4), the control chip 140 suspends or pauses the clock signals CK1 to CK6. The suspend time interval of the clock signals CK1 to CK6 can be J times the clock time interval, i.e., 4 clock time intervals are suspended if J=4, but the suspend time interval can also be defined by the designer or any appropriate time interval. At time t4, after the touch sensing period, the control chip 140 recovers the clock signals CK1 to CK6, and the shift register SR[K+2] outputs the driving signal OUT(K+2), which is identical to the clock signal CK4, to the gate line GLK+1 to serve as the gate driving signal according to the clock signal CK4. In view of this, the rising edge of the specific clock signal VX occurs between the rising edge and the falling edge of the gate driving signal, which is identical to the clock signal CK3, of the shift register SR[K], and the falling edge of the specific clock signal VX occurs between the rising edge and the falling edge of the gate driving signal, which is identical to the clock signal CK4, of the shift register SR[K+2]. In some embodiments, the specific clock signal VX is at a high voltage level during time t2 to t5, and the time interval t2 to t3 can be half of the interval of the clock signal CK3 at a high voltage level. The touch sensing period is from time t3 to t4, and the time interval t4 to t5 can be half of the interval of the clock signal CK3 at a high voltage level. Operations of the shift register SR[K], the dummy shift register SR[K+1], and the shift register SR[K+2] when the gate driving circuit is operated in the reverse scan are the same as that mentioned above, and thus, are omitted for brevity.

In view of this, during the touch sensing periods in the forward/reverse scan, the dummy shift register, such as SR[K+1], enables the shift register SR[K] to perform signal holding/pre-charging and the shift register SR[K+2] to perform pre-charging/signal holding, thereby controlling the rising edge and the falling edge of the gate driving signals for the shift registers SR[K+2] and SR[K] in the forward scan, or controlling the rising edge and the falling edge of the gate driving signals for the shift registers SR[K+2] and SR[K] in the reverse scan. Thus, the output signals (i.e., the driving signals at the signal transmission terminals N and the output terminals OUT) from all the output shift registers, such as SR[1] to SR[K], SR[K+2] to SR[2K+1], have normal rising edges and normal falling edges so that display quality is not degraded. Although the clock signals CK1 to CK6 could be suspended or paused during the touch sensing periods, the dummy shift register enables the adjacent shift registers to perform pre-charging or signal holding according to the specific clock signal VX. Thus, the output signals (i.e., the gate driving signals) from the output shift registers, such as SR[1] to SR[K], SR[K+2] to SR[2K+1], have normal rising edges and normal falling edges so that display quality is not degraded due to the touch sensing periods of the in-cell touch display panel. Compared with the embodiment of FIG. 8, in this embodiment, only one dummy shift register is disposed between two adjacent groups of output shift registers, and thus, the required chip area is decreased. FIG. 11B is a diagram showing clock signals and touch sensing periods when the gate driving circuit shown in FIG. 10 is operated in the reverse scan. Operations of the gate driving circuit is similar to that illustrated in FIG. 11A, and thus, are omitted for brevity.

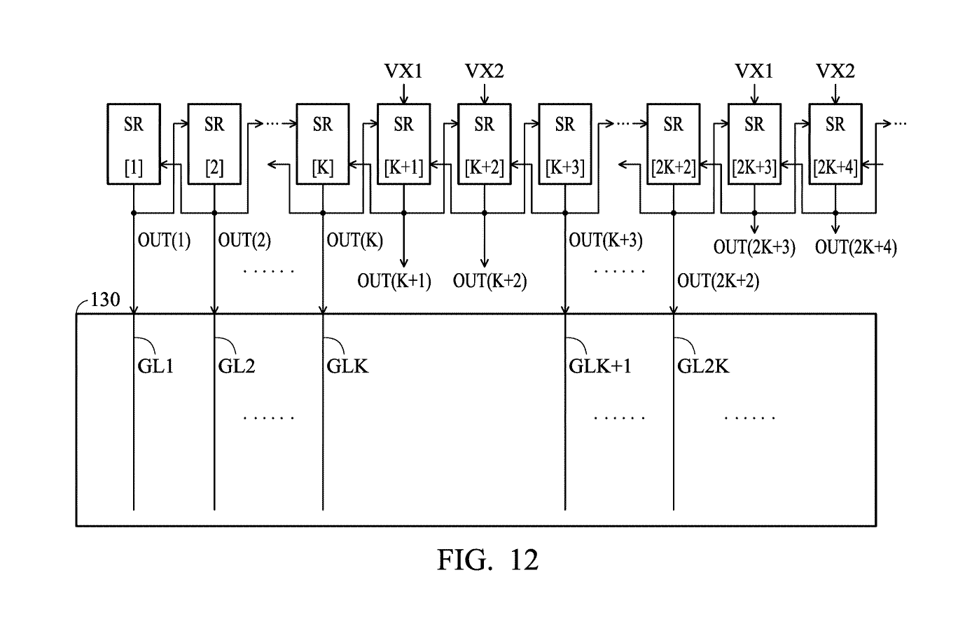

FIG. 12 is another diagram of the gate driving circuit of the present invention. The gate driving circuit shown in FIG. 12 is similar to that shown in FIG. 10, the difference being that the dummy shift registers, such as SR[K+1] and SR[K+2], enable one of the two adjacent output shift registers to perform pre-charging and the other to perform signal holding, according to the specific clock signals VX1 and VX2 provided by the control chip 140. The specific clock signals VX1 and VX2 are not any of the clock signals CK1 to CK6. For example, the dummy shift registers, such as SR[K+1] and SR[K+2], are disposed between the first group of output shift registers, such as SR[1] to SR[K], and the second group of output shift registers, such as SR[K+3] to SR[2K+2]. During a touch sensing period, the dummy shift registers, such as SR[K+1] and SR[K+2], enable the shift register SR[K] to perform signal holding according to the specific clock signal VX1 and enable the shift register SR[K+3] to perform pre-charging according to the specific clock signal VX2. Similarly, the dummy shift registers, such as SR[2K+3] and SR[2K+4], are disposed between the second group of output shift registers and the next group of output shift registers. During the next touch sensing period, the dummy shift registers, such as SR[2K+3] and SR[2K+4], enable the shift register SR[2K+2] to perform signal holding according to the specific clock signal VX1 and enable the shift register SR[2K+5] to perform pre-charging according to the clock signal VX2, and so on.

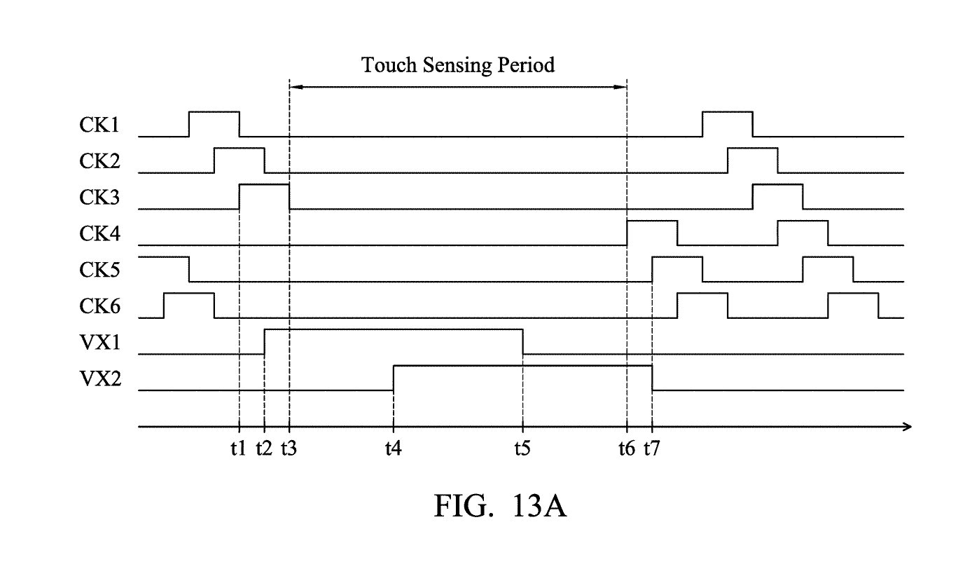

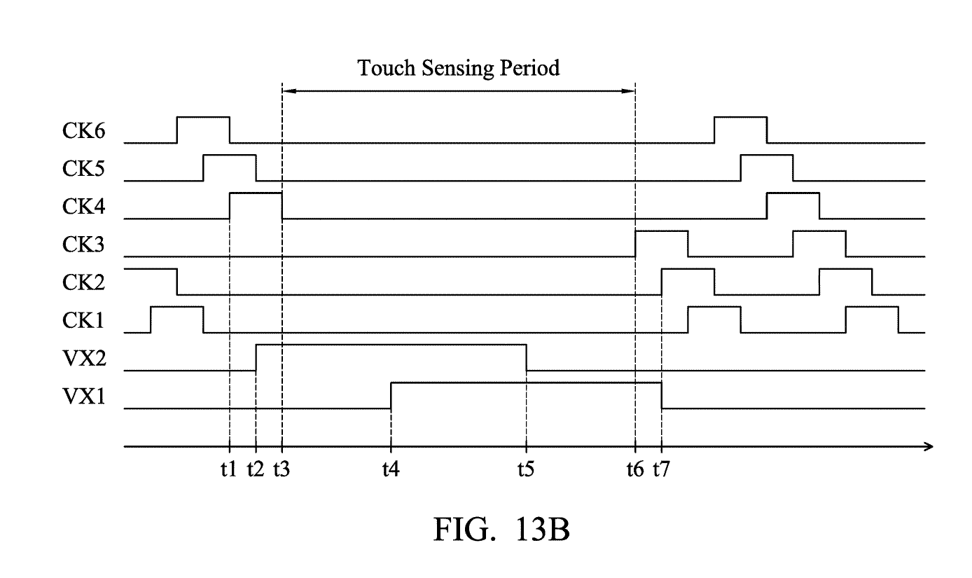

FIG. 13A is a timing diagram of the gate driving circuit shown in FIG. 12 when operating in the forward scan. As shown in FIG. 13A, according to the clock signal CK3, the shift register SR[K] outputs the driving signal OUT(K), which is identical to the pulse of the clock signal CK3, to the gate line GLK to serve as the gate driving signal at time t1 to t3 before the touch sensing period. At time t2 before the touch sensing period, the dummy shift register SR[K+1] outputs the driving signal OUT(K+1) with a high voltage level to the shift registers SR[K] and SR[K+2] according to the specific clock signal VX1. Namely, at time t2 to t3, the shift register SR[K] receives the driving signal OUT(K+1) from the dummy shift register such as SR[K+1], and thus, the transistor M2 in the reverse input circuit 502 of the shift register SR[K] is turned on to perform signal holding on the control node P. During time t2 to t5, the specific clock signal VX1 is at a high voltage level so that the driving signal OUT(K+1) of the dummy shift register SR[K+1] is at a high voltage level. The dummy shift register SR[K+2] outputs the driving signal with a high voltage level to the shift register SR[K+3] according to the specific clock signal VX2 during time t4 to t7. Namely, before the touch sensing period, the shift register SR[K+3] receives the driving signal OUT(K+2) with a high voltage level from the dummy shift register SR[K+2] and thus, the transistor M1 in the forward input circuit 501 of the shift register SR[K+3] is turned on to pre-charge the control node P. In some embodiments, the control chip 140 suspends or pauses the clock signals CK1 to CK6 during time t3 to t6. At time t6, after the touch sensing period, the control chip 140 recovers the clock signals CK1 to CK6, so that the shift register SR[K+3] outputs the driving signal OUT(K+3), which is identical to the clock signal CK4, to the gate line GLK+1 to serve as the gate driving signal according to the clock signal CK4. Operations of the output shift register SR[K], the dummy shift registers SR[K+1] and SR[K+2], and the output shift register SR[K+3] when the gate driving circuit is operated in the reverse scan are the same as that mentioned above, and thus, are omitted for brevity.

The rising edge of the specific clock signal VX1 occurs between the rising edge and the falling edge of the gate driving signal, which is identical to the clock signal CK3, of the shift register SR[K], and the falling edge of the specific clock signal VX1 occurs in the touch sensing period. Furthermore, the rising edge of the specific clock signal VX2 occurs in the touch sensing period, and the falling edge of the specific clock signal VX2 occurs between the rising edge and the falling edge of the gate driving signal, which is identical to the clock signal CK4, of the shift register SR[K+3].

In some embodiments, the specific clock signal VX1 is at a high voltage level during time t2 to t5, and the time interval t2 to t5 can be ⅔ of the time interval t2 to t7. The specific clock signal VX2 is at a high voltage level during time t4 to t7, and the time interval t4 to t7 can be ⅔ of the time interval t2 to t7. During time t4 to t5, the specific clock signals VX1 and VX2 overlap, i.e., both are at a high voltage level. FIG. 13B is a diagram showing clock signals and touch sensing periods when the gate driving circuit shown in FIG. 12 is operated in the reverse scan. Operations of the gate driving circuit is similar to that illustrated in FIG. 13A, and thus are omitted for brevity.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image display system, comprising:
a touch display panel, comprising a pixel matrix with a plurality of pixels; and
a gate driving circuit, arranged to generate a plurality of gate driving signals to drive the pixels of the touch display panel, wherein the gate driving circuit comprises a plurality of shift registers connected in series, and the plurality of shift registers comprises:
a plurality of output shift registers, arranged to output the gate driving signals to a plurality of gate driving lines of the pixel matrix in sequence; and
X groups of dummy shift registers, wherein at least one group of the X groups of dummy shift registers comprises J dummy shift registers and is connected between two adjacent output shift registers of the plurality of output shift registers, wherein at least one driving signal generated by the at least one group of dummy shift registers is partially overlapped with the gate driving signals generated by the two adjacent output shift registers in a frame, wherein the X groups of dummy shift registers are not connected to the plurality of gate driving lines, and X and J are integers greater than zero.

2. The image display system as claimed in claim 1, wherein I output shift registers of the plurality of output shift registers are provided between any two of the adjacent X groups of dummy shift registers, and I is an integer greater than zero

3. The image display system as claimed in claim 1, wherein a size of at least one dummy shift register of the X groups of dummy shift registers is smaller than a size of at least one output shift register of the plurality of output shift registers.

4. The image display system as claimed in claim 1, wherein the at least one group of the X groups of dummy shift registers comprises:
a first dummy shift register, connected to one of the two adjacent output shift registers;
a second dummy shift register, connected to the other of the two adjacent output shift registers; and
a third dummy shift register and a fourth dummy shift register, connected in series between the first and second dummy shift registers, wherein a size of the first and second dummy shift registers is smaller than or equal to a size of each of the two adjacent output shift registers, and a size of the third and fourth dummy shift registers is smaller than or equal to the size of the first and second dummy shift registers.

5. The image display system as claimed in claim 1, wherein the gate driving circuit is included in the touch display panel and generates the gate driving signals according to a group of clock signals, and the touch display panel further comprises:
a data signal transmission circuit, arranged to generate a plurality of data signals and provide the data signals to the pixels of the pixel matrix; and
a control chip, arranged to provide the group of clock signals for controlling the plurality of shift registers.

6. The image display system as claimed in claim 5, wherein J is greater than one and the control chip does not suspend the group of clock signals during a touch sensing period.

7. The image display system as claimed in claim 6, wherein, according to the group of clock signal provided by the control chip, the at least one group of the X groups perform a pre-charge operation and enables the other of the two adjacent output shift registers to perform a signal holding operation.

8. The image display system as claimed in claim 6, wherein J is the same as an amount of pulses of the group of clock signals during the touch sensing period.

9. The image display system as claimed in claim 5, wherein J is greater than one and the control chip suspends the group of clock signals for a pause time interval during a touch sensing period.

10. The image display system as claimed in claim 9, wherein, according to at least one first clock signal provided by the control chip, the at least one group of X groups of the dummy shift registers enables one of the two adjacent output shift registers to perform a pre-charge operation and enables the other of the two adjacent output shift registers to perform a signal holding operation, and the first clock signal is not one of the group of clock signals.

11. The image display system as claimed in claim 10, wherein a rising edge of the first clock signal is between a rising edge and a falling edge of the gate driving signal from one of the two adjacent output shift registers and a falling edge of the first clock signal is between a rising edge and a falling edge of the gate driving signal from the other of the two adjacent output shift registers.

12. A gate driving circuit generating a plurality of gate driving signals to drive a pixel matrix with a plurality of pixels on a touch display panel according to a group of clock signals, and gate driving circuit comprising:
a plurality of shift registers, connected in series and comprising:
a plurality of output shift registers, arranged to output the gate driving signal to a plurality of gate driving lines of the pixel matrix in sequence; and
X groups of dummy shift registers, wherein at least one group of the X groups of dummy shift registers comprises J dummy shift registers and is connected between two adjacent output shift registers of the plurality of the output shift registers, wherein at least one driving signal generated by the at least one group of the X groups of dummy shift registers is partially overlapped with the gate driving signals generated by the two adjacent output shift registers, wherein the X groups of dummy shift registers are not connected to the gate driving lines, and X and J are integers greater than zero.

13. The gate driving circuit as claimed in claim 12, wherein a size of at least one dummy shift register of the X groups of the dummy shift registers is smaller than a size of at least one output shift register of the plurality of output shift registers.

14. The gate driving circuit as claimed in claim 12, wherein the at least one group of the X groups of dummy shift registers comprises:
a first dummy shift register, connected to one of the two adjacent output shift registers;
a second dummy shift register, connected to the other of the two adjacent output shift registers; and
a third dummy shift register and a fourth dummy shift register, connected in series between the first dummy shift register and the second dummy shift register, wherein a size of the first dummy shift register and the second dummy shift register is smaller than or equal to a size of each of the two adjacent output shift registers, and a size of the third dummy shift register and the fourth dummy shift register is smaller than or equal to the size of the first and second dummy shift registers.

15. The gate driving circuit as claimed in claim 12, wherein J is greater than one, and the control chip does not suspend the group of clock signals during a touch sensing period, and J is the same as an amount of pulses of the group of clock signals during the touch sensing period.

16. The gate driving circuit as claimed in claim 15, wherein, according to the group of clock signal provided by the control chip, the at least one group of the X groups of dummy shift registers enables one of the two adjacent output shift registers to perform a pre-charge operation and enables the other of the two adjacent output shift registers to perform a signal holding operation.

17. The gate driving circuit as claimed in claim 12, wherein J is greater than one and the control chip suspends the group of clock signals for a pause time interval during a touch sensing period.

18. The gate driving circuit as claimed in claim 17, wherein, according to a first clock signal provided by the control chip, the at least one group of the X groups of the dummy shift registers enables one of the two adjacent output shift registers to perform a pre-charge operation and enables the other of the two adjacent output shift registers to perform a signal holding operation, and the first clock signal is not one of the group of clock signals.

19. The gate driving circuit as claimed in claim 18, wherein a rising edge of the first clock signal is between a rising edge and a falling edge of the gate driving signal from one of the two adjacent output shift registers and a falling edge of the first clock signal is between a rising edge and a falling edge of the gate driving signal from the other of the two adjacent output shift registers.

20. The gate driving circuit as claimed in claim 17, wherein, according to a first clock signal and a second clock signal provided by the control chip, the at least one group of the X groups of the dummy shift registers enables a previous one of the two adjacent output shift registers to perform a signal holding operation and enables a following one of the two adjacent output shift registers to perform a pre-charge operation, wherein the first clock signal and the second clock signal are not two of the group of clock signals, and the first clock signal is partially overlapped with the gate driving signal from the previous one of the two adjacent output shift registers, and the second clock signal is partially overlapped with the gate driving signal from the following one of the two adjacent output shift registers.
